(19) United States
(12) Patent Application Publication
(10) Pub. No.: US 2004/0055222 A1
(43) Pub. Date: Mar. 25, 2004

(54) Overhead door latch system

(76) Inventors: David L. Rice, Livonia, MI (US); Matthew P. Larowe, Southgate, MI (US); VictorqJ. J. Borowski, Dearborn, MI (US); Malcolm A. McAdam, Dearborn, MI (US)

Correspondence Address: Andrew M. Grove, Reising, Ethington, Barnes, Kisselle, P.C., P.O. Box 4390, Troy, MI, 48099-4390, US

(21) Appl. No.: 10/627,112

(22) Filed: Jul. 24, 2003

Related U.S. Application Data
(60) Provisional application No. 60/398,470, filed on Jul. 25, 2002.

(51) Int. Cl. E05F 1/00

(52) U.S. Cl. 49/449

(57) ABSTRACT

A door latch is provided for vertical sliding doors of the type used in warehouses and loading bays. The latch includes a housing, a latch bolt supported on the housing for sliding movement between a latched position and an unlatched position, and an actuator arm supported on the housing for moving the latch bolt between the latched and unlatched positions. A linkage interconnects the actuator arm and the latch bolt to transmit movement between the actuator arm and the latch bolt, with the linkage including a first end pivotally connected to an end of the latch bolt and a second end pivotally connected to and end of the actuator arm. A pivot pin supported on the housing extends through the actuator arm at a point spaced away from the linkage whereby the actuator arm will move the latch bolt to the unlatched position with movement of the handle end of the actuator arm in either a clockwise or counterclockwise direction about the pivot pin.

### CROSS-REFERENCE TO RELATED APPLICATION

This application claims the benefit of United States provisional application serial number 60/398,470, filed Jul. 25, 2002, the teachings of which are incorporated herein by reference.

### TECHNICAL FIELD

This invention relates to door latch systems and, in particular, to door latch systems for maintaining sliding doors both in a vertical closed position and a vertical overhead open position.

### BACKGROUND OF THE INVENTION

Door latch systems are commonly used to hold a swinging or sliding door in a closed position. These systems generally include a latching mechanism comprising a latch bolt and a corresponding receiver hole on a door track to maintain the door in the closed position. Door latch systems further include an arm, such as an actuator arm, for engaging and disengaging the latch bolt and receiver.

Vertical sliding doors, similar to those used in warehouses and loading bays; slide on a vertical track so that the door is in a vertical position when it is both closed and open. A typical door latch for this type of door is shown in U.S. Pat. No. 4,080,757 to Westerman. This type of latch is intended to latch the door in an open or closed position, and it is designed to unlatch the door by pulling its actuator arm in a downward direction to disengage its latch bolt from a receiver hole in the track. This type of door latch has several drawbacks. First, it is inconvenient and perhaps even difficult to raise the door by pulling down on the actuator arm while simultaneously trying to lift the door. Second, the sliding movement of the latch bolt into and out of a receiver hole in the track involves a significant amount of friction—especially when the latch bolt is supported for sliding movement in a sleeve. The friction problem is compounded when a person creates a vertical force by pulling down on the actuator arm, which forces the latch bolt against the lower side of the receiver hole in the track. The Westerman actuator handle is not designed for maximum mechanical advantage to overcome the friction, because the handle does not achieve maximum torque until it is well into its arc of travel.

Thus, it is an object of the present invention to provide a door latch system that can be opened or closed with a single easy and fluid motion, and with minimum resistance due to friction. It is a further object of the present invention to provide a robust and durable door latch system capable of securing and maintaining a vertical sliding door in either an open overhead position or a closed down position.

### SUMMARY OF THE INVENTION

According to one aspect of the present invention, there is a door latch including a housing, a latch bolt supported on the housing for sliding movement between an extended latched position and a retracted unlatched position, and an actuator arm supported on the housing for moving the latch bolt between the latched and unlatched positions. The actuator arm extends between a handle end and a linkage end. A linkage interconnects the actuator arm and the latch bolt to transmit movement between the actuator arm and the latch bolt, with the linkage including a first end pivotally connected to the latch bolt and a second end pivotally connected to the actuator arm. A pivot pin supported on the housing extends through the actuator arm at a point spaced away from the linkage end whereby the actuator arm will move the latch bolt to the unlatched position with movement of the handle end in either a clockwise or counterclockwise direction about the pivot pin.

According to another aspect of the invention, there is a door latch including a housing, a latch bolt supported on the housing for sliding movement between an extended latched position and a retracted unlatched position, and an actuator arm supported on the housing for moving the latch bolt between the latched and unlatched positions. A linkage interconnects the actuator arm and the latch bolt to transmit movement between the actuator arm and the latch bolt. There is also at least one roller associated with the latch bolt for supporting the latch bolt in its sliding movement whereby the friction of the sliding movement is minimized.

According to yet another aspect of the invention, there is a vertical sliding door assembly including first and second door tracks oriented vertically and spaced apart from each other, with at least one of the tracks defining a top receiver hole near the top end of the track and a bottom receiver hole near the bottom end of the track. A sliding door is supported for vertical sliding movement in the first and second tracks between a down position and an up position, the door having a top edge and a bottom edge. A latch bolt is supported on the door near the bottom edge for sliding movement between an extended latched position in which the bolt extends into one of the top and bottom receiver holes, and a retracted unlatched position in which the bolt retracts out of the holes. An actuator arm supported on the door moves the latch bolt between the latched and unlatched positions. A linkage interconnects the actuator arm and the latch bolt to transmit movement between the actuator arm and the latch bolt. A pivot pin supported on the door extends through the actuator arm near one of its ends whereby the actuator arm will move the latch bolt to the unlatched position with movement of the handle end in either a clockwise or counterclockwise direction about the pivot pin.

The present invention overcomes the disadvantages of the prior art and provides a door latch system that can be opened or closed with a single easy and fluid motion, and with minimum resistance due to friction. The invention also provides a robust and durable door latch system capable of securing and maintaining a vertical sliding door in either an open overhead position or a closed down position.

### FIGURES IN THE DRAWINGS

Other advantages of the present invention will be readily appreciated as the same becomes better understood by reference to the following detailed description when considered in connection with the accompanying drawings wherein:

FIG. 1A is a front view showing a vertical overhead door assembly in a closed position with the door latch mounted near the lower edge of the door;

FIG. 1B is a view similar to FIG. 1A showing the door in the open position;

FIG. 2 is a front perspective view of the door latch showing the rollers, the latch bolt, and the stabilizing flange on the housing;

FIG. 3 is a different front perspective view of the door latch showing the latch bolt engaging the large receiving hole at the top of the track;

FIG. 4A is a front view of the door latch with the cover in phantom showing the latch in an unlatched condition with the actuator arm down;

FIG. 4B is a front view of the door latch with the cover in phantom showing the latch in the latched condition;

FIG. 4C is a front view of the door latch with the cover in phantom showing the latch in an unlatched condition with the actuator arm up; and

FIG. 5 is an exploded perspective view of the door latch.

### DESCRIPTION OF THE PREFERRED EMBODIMENT

Referring to the Figures wherein like numerals indicate like or corresponding parts throughout the several views, a door latch for latching and unlatching a vertical door is generally shown at 10.

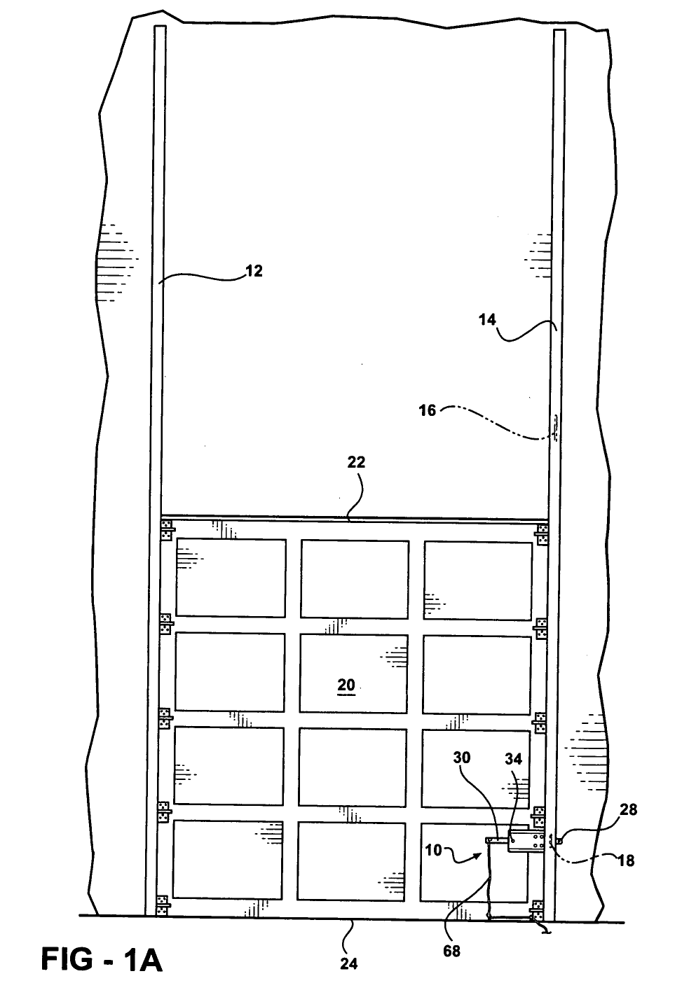

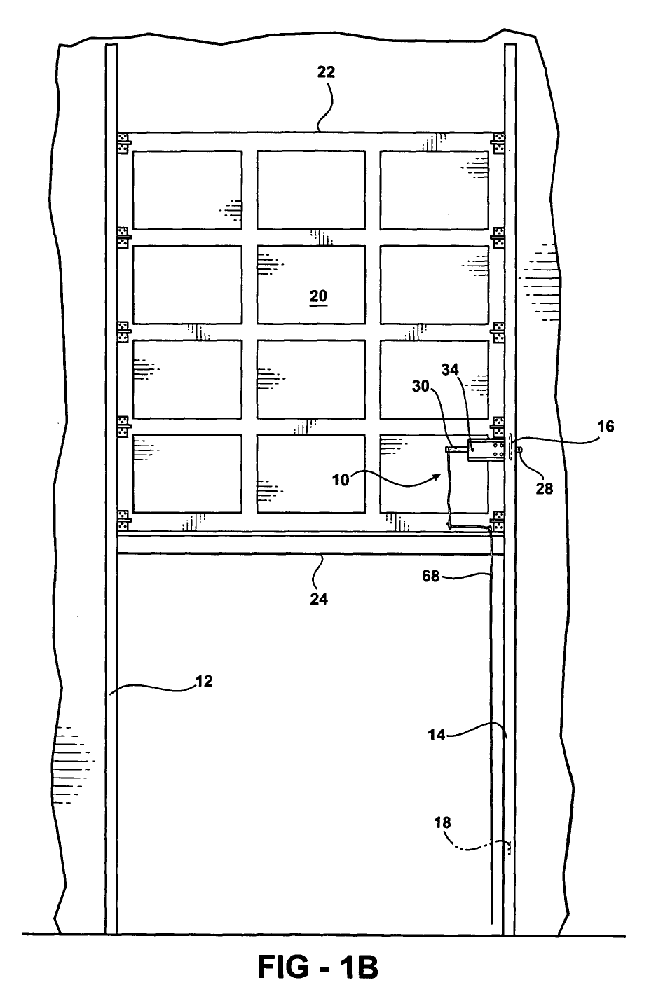

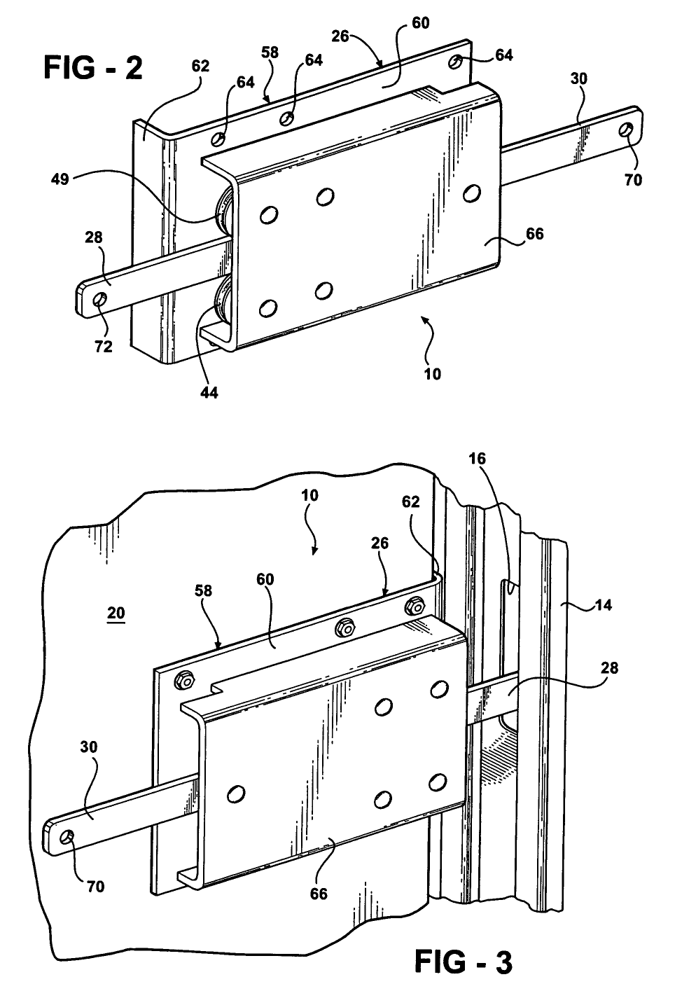

FIGS. 1A and 1B show the environment in which the latch 10 is preferably employed. It is a doorway for a warehouse or a loading bay including first and second door tracks 12, 14 oriented vertically and spaced apart from each other. At least one of the tracks 12, 14 defines a top receiver hole 16 near the top end of the track and a bottom receiver hole 18 near the bottom end of the track. The top receiver hole 16 is larger in the vertical direction than the bottom receiver hole 18. There is also a sliding door 20 supported for vertical sliding movement in the first and second tracks 12, 14 between a down position and an up position, the door having a top edge 22 and a bottom edge 24.

The door latch 10 preferably includes a housing generally indicated at 26, and a piston or latch bolt 28 supported on the housing for sliding movement between an extended latched position and a retracted unlatched position. The door latch 10 also includes a crank or actuator arm 30 supported on the housing 26 for moving the latch bolt 28 between the latched and unlatched positions, the actuator arm 30 extending between a handle end and a linkage end. A rod or linkage 32 interconnects the actuator arm 30 and the latch bolt 28 to transmit movement between the actuator arm 30 and the latch bolt 28. The linkage 32 includes a first end pivotally connected to the latch bolt 28 and a second end pivotally connected to the actuator arm 30. A pivot pin 34 is supported on the housing 26 and extends through the actuator arm 30 at a point spaced away from the linkage end whereby the actuator arm 30 will move the latch bolt 28 to the unlatched position with movement of the handle end in either a clockwise or counterclockwise direction about the pivot pin 34.

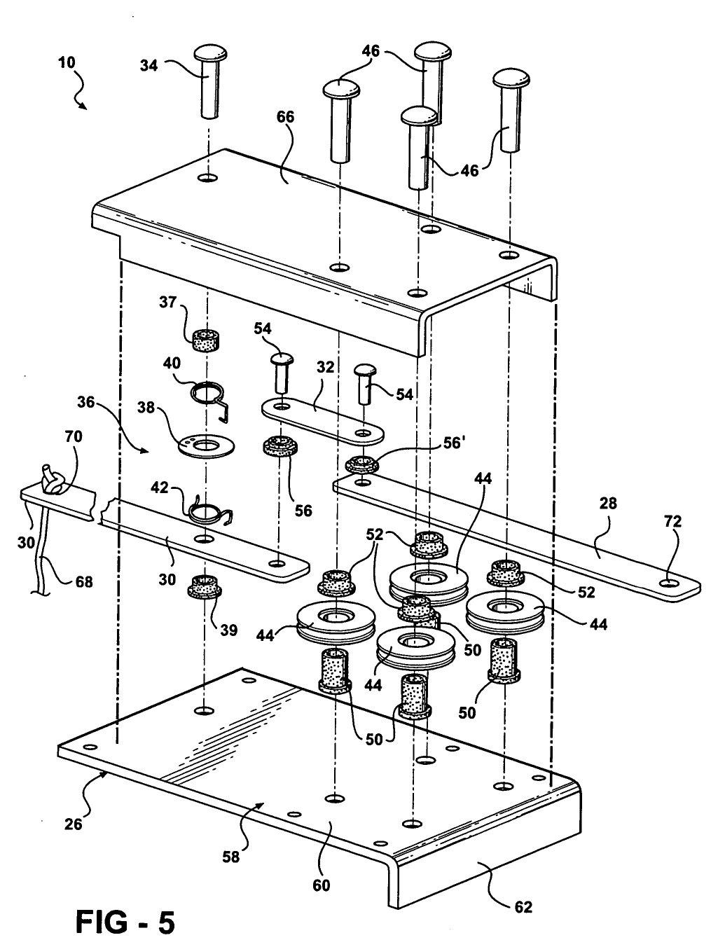

The pivot pin 34 is preferably a rivet that extends through the housing 26 as shown in the Figures. As shown in FIG. 5, a washer bearing 37 is disposed around the pivot pin 34 along a length of the pivot pin, and a spacer bearing 39 is also disposed around the pivot pin 34 along a different length of the pivot pin. The bearings 37, 39 facilitate low friction pivoting of the actuator arm 30 about the pivot pin 34, and they also help maintain the actuator arm in its desired position in the housing 26. The bearings 37, 39 are off-the-shelf bearings impregnated with oil and Teflon® chips for smooth and low friction support even with intermittent use.

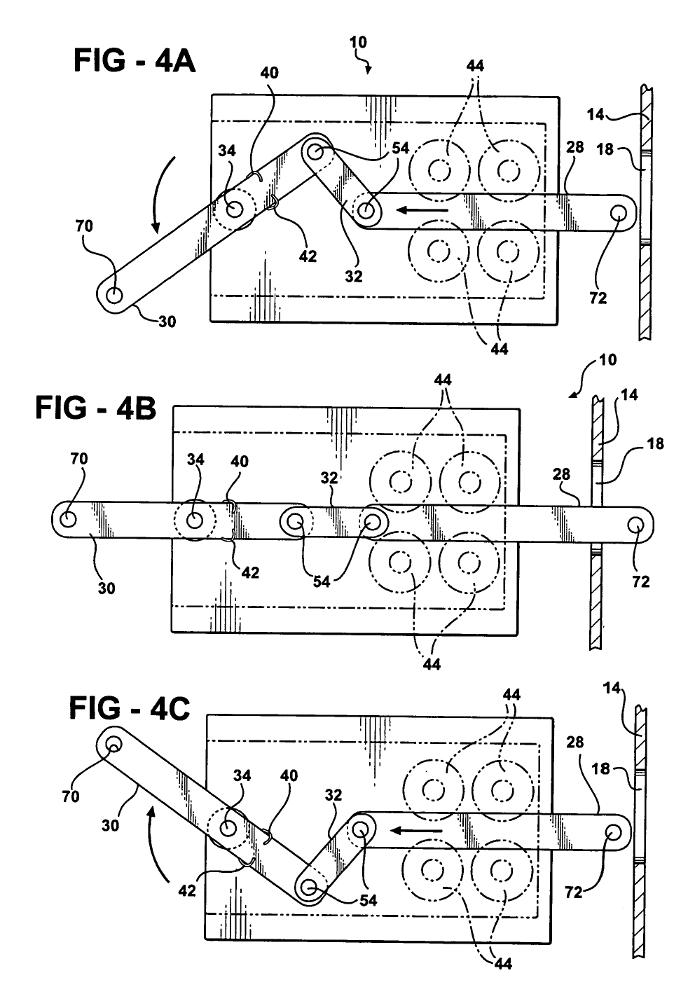

The door latch 10 includes a spring mechanism generally indicated at 36 associated with either the actuator arm 30 or the latch bolt 28 for biasing the latch bolt 28 into the latched position. The spring mechanism 36 can take on a variety of forms. The objective is to bias the latch bolt 28 into the extended latched position. The spring mechanism 36 could include a helix spring, a torsion spring, a leaf spring, or any other suitable spring known to persons of skill in the art; and such springs could be associated directly or indirectly with the actuator arm 30 and/or the latch bolt 28. In a presently preferred embodiment, the spring mechanism 36 includes a washer 38 disposed around the pivot pin 34 and the washer bearing 37, a first torsion spring 40 disposed on one side of the washer, and a second torsion spring 42 disposed on the other side of the washer, each spring having a first end contacting the washer and a second end contacting the actuator arm as shown in FIGS. 4 and 5. The first ends of the springs 40, 42 fit in holes in the washer 38. The second ends extend around opposite sides of the actuator arm 30 to bias it into the middle position shown in FIG. 4C, which causes the latch bolt to be in the extended latched position. This particular arrangement is advantageous because the spring mechanism 36 is efficiently packaged inside the housing 26 where it is protected. The spring mechanism 36 could alternatively include torsion springs having ends contacting the housing 26. Another version of the spring mechanism 36 could include a helical spring having one end attached to the housing, and one end attached to the latch bolt 28. Yet another version of the spring mechanism 36 could include a compression spring disposed between the housing 26 and either the latch bolt 28 or the actuator arm 30.

The door latch 10 includes at least one roller 44 supported on the housing 26 adjacent the latch bolt 28 for supporting the latch bolt in its sliding movement. Ideally, the door latch 10 includes first and second rollers 44 supported on the housing 26 above the latch bolt 28, and third and fourth rollers 44 supported on the housing below the latch 28 bolt for supporting the latch bolt in its sliding movement. Alternatively, people of ordinary skill in the art will appreciate that the rollers 44 can be attached to the latch bolt 28 to move with it with respect to the housing 26. The rollers 44 can be of several types. Preferably, though, the rollers 44 are sheaves each supported on the housing with a post 46 and a bearing assembly 50, 52 disposed between the post 46 and the sheave 44. The sheaves 44 guide and support the latch bolt 28. The posts 46 can be any type of fastener. In the presently preferred embodiment the posts 46 are rivets extending through the housing. These rivets 46 and the rivet 34 are countersunk in the housing 26 so that the housing 26 has a flat surface for mounting to the door 20.

As best shown in FIG. 5, the bearing assembly 50, 52 includes a pair of flange bearings. A long bearing 50 extends through the sheave 44 and supports it for rotating movement. A short bearing 52 acts to space the sheave 44 from the housing 26. Each sheave 44 defines a disc-like groove, as shown in FIG. 5 to provide clearance for the flange on the short bearing 52. The bearings 50, 52 are off-the-shelf flange bearings impregnated with oil and Teflon® chips for smooth and low friction support even with intermittent use.

The linkage 32 is connected at one of its ends to the actuator arm 30 with a rivet 54 or a similar fastener that permits pivoting movement of the linkage 32 with respect to the actuator arm 30. A thrust washer 56 is further provided to facilitate low friction pivoting movement. The thrust washer 56 is an off-the-shelf item made from the same material used in the bearings described above. The linkage 32 attaches at its other end to the latch bolt 28 with a similar rivet and thrust washer arrangement 54, 56′. In that connection, though, the thrust washer 56′ may need to be slightly thinner to provide for ideal alignment among the actuator arm 30, the linkage 32, and the latch bolt 28.

The housing 26 includes a base plate generally indicated at 58 having a door mounting plate 60 and a stabilizing flange 62 extending perpendicularly down from the mounting plate. The door mounting plate 60 is flat and includes at its edges several holes 64 for receiving fasteners to fasten the mounting plate 60 to the door 20. As mentioned above, rivets 34 and 46 are countersunk in this plate 60 so that the plate 60 presents a flat surface to the door. The base plate 58 is adapted to be mounted at the edge of the door 20 adjacent the track 12 or 14 with the mounting plate 60 on a surface of the door and the stabilizing flange 62 on an adjacent perpendicular surface around the edge of the door. This arrangement provides for support on a door 20 that may be relatively thin. The mounting plate 60 and stabilizing flange 62 spread forces acting on the latch 10 during its operation to minimize unwanted twisting forces that can adversely affect the door 20 and the fasteners that attach the latch 10 to the door. The housing 26 also includes a dust cover 66 secured to the base plate 58. Preferably the parts of the latch 10 are arranged in the housing 26 between the base plate 58 and the dust cover 66, where the dust cover is secured to the base plate in some desirable manner—e.g. with welding or fasteners. The dust cover 66 protects the latch parts from the environment, and minimizes risks that something can get caught in the latch parts when they are operating. In general, the design of the latch 10 minimizes or eliminates any sharp edges or moving parts that could snag clothing or the like.

The housing 26 itself is desirable, though not strictly necessary. The operative parts of the latch 10 can be mounted directly on the door, where those parts include the latch bolt 28, the actuator arm 30, the linkage 32, and the pivot pin 34.

The operation of the latch 10 is illustrated best in FIGS. 4A-4C. The latch 10 is shown in the rest position in FIG. 4B where the latch bolt 28 is in the extended latched position. As shown in FIGS. 4A and 4C, one can move the latch bolt 28 into the retracted unlatched position by moving the actuator arm 30 either in a downward counterclockwise direction relative to the pivot pin 34, or in an upward clockwise direction. In either case, the actuator arm 30 is positioned to take maximum mechanical advantage and use maximum torque to retract the latch bolt 28, even from a confined opening of the type shown at 18 in FIGS. 4A-C. The rollers 44 and bearings 50, 52 further assist in providing low friction movement of the latch bolt 28.

The latch 10 is thus very convenient and easy for a person to operate. A person can unlatch the door 20 with a single lifting effort; and can close and latch the door 20 with a single pulling effort. Moreover, because the actuator arm 30 can operate in either the up or down direction, the latch 10 is versatile in the sense that it can be used on either side of the door 20. If a person desires to open the door 20, the person simply pulls up on the actuator arm 30, and the latch bolt 28 will retract from the bottom receiver hole 18. The end of the latch bolt 28 will ride along the track 14 until reaching the top receiver hole 16, where it will bias into the hole 16 and latch. The hole 16 is oversized to receive the latch bolt 28 even if the latch bolt is moving rapidly past the hole 16. The person can close the door 20 by pulling down on the actuator arm 30. This will pull the latch bolt 28 out of the top hole 16, and the bolt 28 will ride down the track 14 until it pops or biases into the bottom hole 18. The bottom hole 18 is only slightly larger than the latch bolt 18 to prevent unwanted movement of the door 20 when the door is closed and possibly locked.

The invention may include a rope arrangement 68 as shown in FIGS. 1A and 1B, where the rope may be routed through eyelets or pulleys. One or more ropes may assist in operating the latch if the latch 10 is out of reach of the operator. If a rope arrangement 68 is necessary, it can be secured through a hole 70 formed in the actuator arm 30.

The invention may include further refinements, like a lock hole 72 formed in the end of the latch bolt 28. The lock hole 72 is sized to receive a conventional padlock if the user desires to lock the door 20 shut.

The materials for constructing the latch 10 may vary, but ideally the materials are heavy gauge, or otherwise selected for strength and durability. It will of course be understood that the foregoing description is of preferred exemplary embodiments of the invention and that the invention is not limited to the specific embodiments shown. Various changes and modifications will become apparent to those skilled in the art.

We claim:

1. A door latch for a door including:
a housing;
a latch bolt supported on the housing for sliding movement between an extended latched position and a retracted unlatched position;
an actuator arm supported on the housing for moving the latch bolt between the latched and unlatched positions, the actuator arm extending between a handle end and a linkage end;
a linkage interconnecting the actuator arm and the latch bolt to transmit movement between the actuator arm and the latch bolt, the linkage including a first end pivotally connected to the latch bolt and a second end pivotally connected to the actuator arm; and
a pivot pin supported on the housing and extending through the actuator arm at a point spaced away from the linkage end whereby the actuator arm will move the latch bolt to the unlatched position with movement of the handle end in either a clockwise or counterclockwise direction about the pivot pin.

2. The door latch of claim 1 further including a spring mechanism associated with one of the actuator arm and the latch bolt for biasing the latch bolt into the latched position.

3. The door latch of claim 1 further including at least one roller supported on the housing adjacent the latch bolt for supporting the latch bolt in its sliding movement.

4. The door latch of claim 3 further including first and second rollers supported on the housing above the latch bolt, and third and fourth rollers supported on the housing below the latch bolt for supporting the latch bolt in its sliding movement.

5. The door latch of claim 2 wherein the spring mechanism includes a washer disposed on the pivot pin, a first torsion spring disposed on one side of the washer, and a second torsion spring disposed on the other side of the washer, each spring having a first end contacting the washer and a second end contacting the actuator arm.

6. The door latch of claim 4 wherein the rollers are sheaves each supported on the housing with a post and a bearing assembly disposed between the post and the sheave.

7. The door latch of claim 1 wherein the housing includes a base plate having a door mounting plate and a stabilizing flange extending perpendicularly down from the door mounting plate whereby the base plate is adapted to be mounted at the edge of the door with the base plate on a surface of the door and the stabilizing flange on an adjacent perpendicular surface of the door.

8. The door latch of claim 7 wherein the housing includes a dust cover fastened to the base plate.

9. A door latch for a door including:
a housing;
a latch bolt supported on the housing for sliding movement between an extended latched position and a retracted unlatched position;
an actuator arm supported on the housing for moving the latch bolt between the latched and unlatched positions; and
a linkage interconnecting the actuator arm and the latch bolt to transmit movement between the actuator arm and the latch bolt; and
at least one roller associated with the latch bolt for supporting the latch bolt in its sliding movement relative to the housing whereby the friction of the sliding movement is minimized.

10. The door latch of claim 9 further including first and second rollers supported on the housing above the latch bolt, and third and fourth rollers supported on the housing below the latch bolt for supporting the latch bolt in its sliding movement.

11. The door latch of claim 10 wherein the rollers are sheaves each supported on the housing with a post and a bearing assembly disposed between the post and the sheave.

12. A vertical sliding door assembly including:
first and second door tracks oriented vertically and spaced apart from each other, with at least one of the tracks defining a top receiver hole near the top end of the track and a bottom receiver hole near the bottom end of the track;
a sliding door supported for vertical sliding movement in the first and second tracks between a down position and an up position, the door having a top edge and a bottom edge;
a latch bolt supported on the door near the bottom edge for sliding movement between an extended latched position in which the bolt extends into one of the top and bottom receiver holes, and a retracted unlatched position in which the bolt retracts out of the holes;
an actuator arm supported on the door for moving the latch bolt between the latched and unlatched positions;
a linkage interconnecting the actuator arm and the latch bolt to transmit movement between the actuator arm and the latch bolt; and
a pivot pin supported on the door and extending through the actuator arm near one of its ends whereby the actuator arm will move the latch bolt to the unlatched position with movement of the handle end in either a clockwise or counterclockwise direction about the pivot pin.
